(19) United States
(12) Patent Application Publication
(10) Pub. No.: US 2022/0240082 A1
(43) Pub. Date: Jul. 28, 2022

(54) TEXT MESSAGE PROCESSING METHOD AND SYSTEM, TERMINAL DEVICE AND STORAGE MEDIUM

(71) Applicant: ZTE CORPORATION, Shenzhen, Guangdong (CN)

(72) Inventor: Jinguang ZHANG, Shenzhen, Guangdong (CN)

(21) Appl. No.: 17/616,655

(22) PCT Filed: Aug. 27, 2020
(86) PCT No.: PCT/CN2020/111601

§ 371 Date: Dec. 5, 2021

(30) Foreign Application Priority Data
Aug. 29, 2019 (CN) 201910809693.1

(51) Int. Cl. H04W 12/02; H04L 9/40; H04W 4/12

(52) U.S. Cl. CPC H04W 12/02; H04W 4/12; H04L 63/166

(57) ABSTRACT

The present disclosure provides a text message processing method, a text message processing system, a terminal device and a storage medium. The text message processing method includes: acquiring a text message by a telecommunication framework layer; determining, by the telecommunication framework layer, whether the text message is a private text message according to a preset rule; in response to that the text message is the private text message, sending the text message to a specified system application by the telecommunication framework layer; and storing, by the specified system application, the text message in a private text message database, which is accessible to the specified system application.

### TECHNICAL FIELD

The present disclosure relates to the field of communication technology, and in particular, to a text message processing method, a text message processing system, a terminal device and a storage medium.

### BACKGROUND

For general users, text messages concerning bank transactions, various login verification codes and express delivery are frequently received in daily life, and the contents of those text messages usually relate to financial information, account information or other important information of the users. If the important information is not properly protected and is leaked, the leakage of the information is very dangerous for the users. Basic third-party communication software has become more and more in recent years, and the software can be easily installed and can easily acquire text message permission to receive information and access a database, resulting in easy acquisition of the important information of the users by the third parties.

In view of the above problem, it is detected in the existing art whether a text message contains a verification code; if the text message contains a verification code, a target field in the text message is acquired and is replaced with a ciphertext field to obtain a ciphertext message which is then displayed; and the target field is displayed in plaintext form when a message decryption instruction is received.

In processes of protecting existing text messages with the above solution, the confidentiality of the text messages containing verification codes is considered, but the confidentiality of other text messages containing important information are not considered. In addition, the above solution can keep the text messages containing verification codes secret in receiving processes thereof, and does not store the text messages containing verification codes in a different way from that of the other messages. Therefore, the problem of information leakage of the text messages containing verification codes is still likely to be caused in storage processes of the text messages.

### SUMMARY

In an aspect, an embodiment of the present disclosure provides a text message processing method, which includes:

acquiring a text message by a telecommunication framework layer;

determining, by the telecommunication framework layer, whether the text message is a private text message according to a preset rule;

in response to that the text message is the private text message, sending the text message to a specified system application by the telecommunication framework layer; and

storing, by the specified system application, the text message in a private text message database, which is accessible to the specified system application.

In another aspect, an embodiment of the present disclosure provides a text message processing system, which includes:

a telecommunication framework layer configured to acquire a text message, determine whether the text message is a private text message according to a preset rule, and send the text message to a specified system application in response to that the text message is the private text message; and

a specified system application configured to store the text message in a private text message database, which is accessible to the specified system application.

In still another aspect, an embodiment of the present disclosure provides a terminal device, which includes a storage device having a computer program stored therein, and a processor, the processor runs the computer program stored in the storage device to perform the above text message processing method.

In yet another aspect, an embodiment of the present disclosure provides a computer-readable storage medium having a computer program stored therein, the computer program is executed by a processor so that the above text message processing method is performed.

Other features and advantages of the present disclosure will be described in the following description, and can become partially apparent from the description or be understood through the implementation of the present disclosure. The advantages of the present disclosure can be achieved and obtained through the structures particularly pointed out in the description, claims and drawings.

### BRIEF DESCRIPTION OF DRAWINGS

The accompanying drawings are used to provide a further understanding of the technical solutions of the present disclosure and constitute a part of the specification. The drawings together with the embodiments of the present disclosure are used to explain the technical solutions of the present disclosure, and do not make a limitation on the present disclosure.

FIG. 1 is a flowchart illustrating a text message processing method according to an embodiment of the present disclosure;

FIG. 2 is a diagram of a process of sending text message by a telecommunication framework layer to a specified system application according to an embodiment of the present disclosure;

FIG. 3 is a flowchart illustrating a text message processing method according to an embodiment of the present disclosure;

FIG. 4 is a schematic diagram of a private text message database and a public text message database according to an embodiment of the present disclosure;

FIG. 5 is a flowchart illustrating a text message processing method according to an embodiment of the present disclosure;

FIG. 6 is a schematic structural diagram of a text message processing system according to an embodiment of the present disclosure;

FIG. 7 is a schematic structural diagram of a telecommunication framework layer according to an embodiment of the present disclosure; and

FIG. 8 is a schematic structural diagram of a terminal device according to an embodiment of the present disclosure.

### DETAIL DESCRIPTION OF EMBODIMENTS

In order to make the technical solutions and advantages of the embodiments of the present disclosure clearer, the specific embodiments of the present disclosure are further described in detail below with reference to the drawings. It should be understood that the specific embodiments described herein are merely intended to describe and explain the present disclosure, rather than limiting the present disclosure.

It should be noted that the embodiments of the present disclosure and the features thereof can be arbitrarily combined with one another if no conflict is incurred.

In the following description, the terms such as “module”, “component” and “unit” used to indicate elements are employed for facilitating the description of the present disclosure, and those terms have no particular meaning in themselves. Thus, “module”, “component” and “unit” can be used together.

The terminal device of the present disclosure may be implemented in various forms. For example, the terminal device described in the present disclosure may include a smart mobile terminal capable of receiving a text message, such as a mobile phone, and a smart fixed terminal capable of receiving text message, such as a smart fixed phone. A smart mobile terminal (e.g., a mobile phone) is taken as an example in the following description. However, it should be understood by those of ordinary skill in the art that the structures according to the embodiments of the present disclosure except for the elements specifically used for mobile purposes can also be applied to a fixed terminal device capable of receiving a text message.

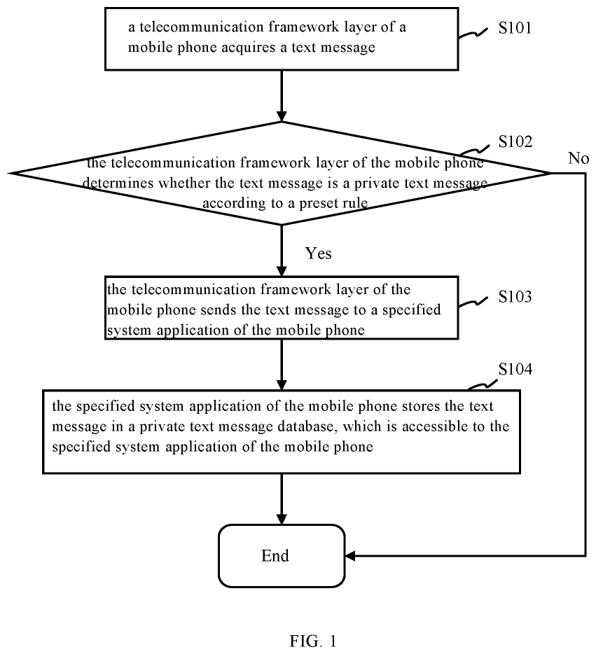

An embodiment of the present disclosure provides a text message processing method applicable to a mobile phone. With reference to FIG. 1 which is a flowchart illustrating a text message processing method according to an embodiment of the present disclosure, the text message processing method includes following operations S101 to S104.

At the operation S101, a telecommunication framework layer of a mobile phone acquires a text message.

Specifically, the telecommunication framework layer of the mobile phone acquires the text message, which is sent by a text message sender to the mobile phone, from a base station. The text message sender may be another mobile phone, a shopping web site, a mobile application (APP), or a platform capable of sending a text message, such as a Text message Service (SMS) server of a financial enterprise.

It should be noted that the telecommunication framework layer is one of framework layers, and the framework layer in the embodiment of the present disclosure is an application framework layer. The application framework layer is an Application Programming Interface (API) framework used by a core application in an Android System, and provides an application layer with various APIs including an Activity Manager (which manages a life cycle of each application and a general navigation rollback function), a Window Manager (which manages all window programs) and a View System (a basic component for constructing an application), activities including a Process, an application/package, a Service and Task information, which are running in a system, can be obtained by the Activity Manager. Various websites, mobile APPs and the like can send a text message to the mobile phone by accessing an SMS interface of the mobile phone, and the telecommunication framework layer of the mobile phone can acquire the text message sent by the text message sender.

To better understand the framework layer, the framework layer is further illustrated below in the embodiment. An Android mobile operating system is a layered smartphone operating system based on a Linux kernel, and is divided into four layers from top to bottom: an application layer (i.e., Java Application) including various Android applications; an application framework layer (i.e., Java frameworks) which is an API framework used by a core application; a system runtime library layer (i.e., User Libraries) including a C/C++ core library, a Dalvik virtual machine running environment and an HAL sublayer, which are desirable for a mobile phone system platform; and a kernel layer (i.e., Linux Kernel) which provides core system services, such as file management, memory management, process management, network stacking, driver model, and other basic service capabilities of the operating system.

At the operation S102, the telecommunication framework layer of the mobile phone determines whether the text message is a private text message according to a preset rule, and in response to that the text message is the private text message, the operation S103 is performed; in response to that the text message is a non-private text message, the process is terminated.

In the existing art, when a telecommunication framework layer receives a new text message, the telecommunication framework layer sends the new text message directly to a default SMS application for processing, and the default SMS application writes the received new text message to a public database. When the default SMS application processes the new text message, a third-party application can easily check the new text message; when the default SMS application writes the new text message to the public database, the third-party application can easily access the new text message; moreover, the third-party application can easily leak the content of the text message through the background, which is very prone to a security risk of the text message of the user.

Compared with the existing art, in the operation S102 of the embodiment, after the telecommunication framework layer of the mobile phone receives a new text message, the telecommunication framework layer determines a security property of the new text message in real time, that is, determines whether the new text message is a private text message or a non-private text message (i.e., a common text message) of the user. In the embodiment, the private text message includes at least one of the following information: information about a bank transaction record, information about a verification code, express pickup information or other information preset by the user.

In practical applications, users in various industries frequently receive the text messages concerning bank transactions, various login verification codes and express delivery, the contents of those text messages usually relate to financial information, account information or other important information of the users. Once the important information is leaked, damages to property or other benefit of the users may be caused. It should be noted that, with the continuous development of economy and the growing concern for privacy of text message from the users, the users may further preset relevant text messages as private text messages for protection except for the text messages concerning bank transactions, various login verification codes and express delivery. For example, a text message about a technical solution, a text message about commodity pricing, or various other text messages that should be protected in the opinion of the users, such as a text message about basic personal information.

It should be noted that the technical solution provided by the embodiment can be widely applied to user groups in different industries and ensure the security of personal information better, has a wider application range and is low in cost.

At the operation S103, the telecommunication framework layer of the mobile phone sends the text message to a specified system application of the mobile phone.

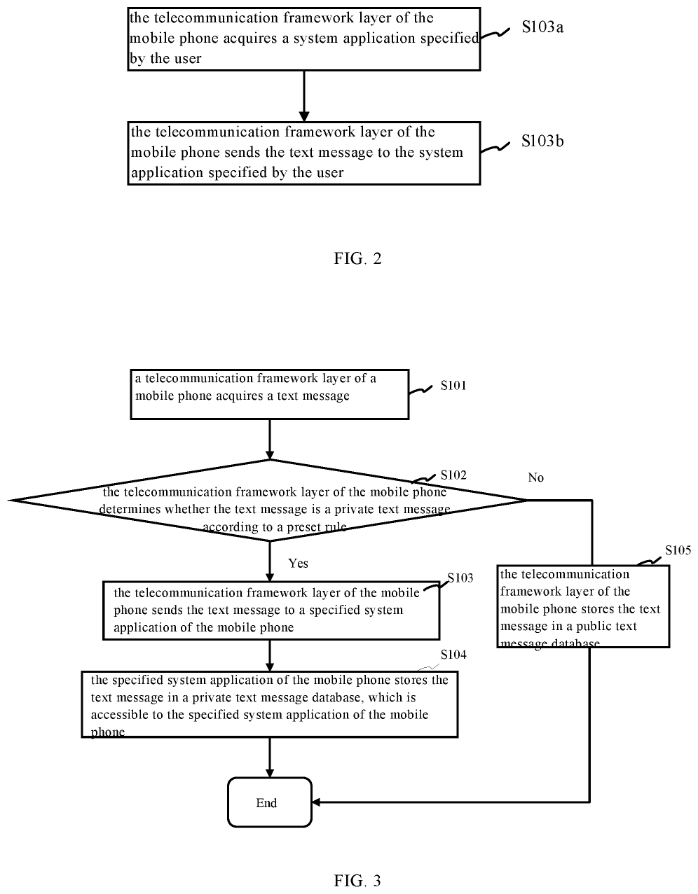

With reference to FIG. 2 which is a flowchart of the operation S103, in some implementations, the operation of sending the text message by the telecommunication framework layer of the mobile phone to the specified system application of the mobile phone specifically includes the following operations S103a and S103b.

At the operation S103a, the telecommunication framework layer of the mobile phone acquires a system application specified by the user.

In the embodiment, the telecommunication framework layer acquires the system application specified by the user after identifying the new text message as the private text message. In some implementations, the user may specify the system application in the following ways: after the telecommunication framework layer identifies the new text message as the private text message, the mobile phone calls a program to pop up a system application selection window, and the user specifies the corresponding system application according to the private text message; or, the user may specify the system application through an input, the telecommunication framework layer sends the private text message to the system application specified by the user, and the private text message may be checked, stored and called by the specified system application.

It should be noted that, for different types of private text messages, the user may specify the corresponding system application according to a sending source or contents of the private text messages.

At the operation S103b, the telecommunication framework layer of the mobile phone sends the text message to the system application specified by the user.

In the embodiment, the telecommunication framework layer of the mobile phone sends the private text message to the system application specified by the user, and the system application specified by the user is allowed to read the private text message, which prevents a third-party application from checking the private text message, thereby effectively avoiding information leakage.

At the operation S104, the specified system application of the mobile phone stores the text message in a private text message database, which is accessible to the specified system application of the mobile phone, and the process is terminated.

Specifically, after receiving the private text message, the specified system application of the mobile phone may check the private text message and store the private text message in the private text message database, which is accessible to the specified system application, that is, the specified system application has the permission to check and access the private text message. Thus, the private text message is isolated, which prevents the third-party application from accessing the private text message and easily leaking the contents of the private text message through the background, thereby effectively ensuring the security of private information of the user.

Another embodiment of the present disclosure provides a text message processing method, including operations S101 to S105. It should be noted that the operations S101 to S104 in this embodiment are the same as those in the above embodiment, and thus are not repeated here.

With reference to FIG. 3, a telecommunication framework layer of a mobile phone determines whether text message is a private text message according to a preset rule (i.e., the operation S102), and the operation S105 is performed in response to that the text message is a non-private text message.

At the operation S105, the telecommunication framework layer of the mobile phone stores the text message in a public text message database, which is accessible not only to a specified system application of the mobile phone but also to third-party applications except the specified system application of the mobile phone, and the process is terminated.

Specifically, in order to make it easy for an operator platform to implement a corresponding marketing strategy among users, the operator platform may access contents of corresponding text messages of the users under the condition of no invasion of privacy of the users. In the embodiment, when it is determined that the text message is a non-private text message, that is, a common text message that does not invade the privacy of the user, the telecommunication framework layer of the mobile phone stores the text message in the public text message database, which is accessible not only to the specified system application of the mobile phone but also to the third-party applications except the specified system application of the mobile phone.

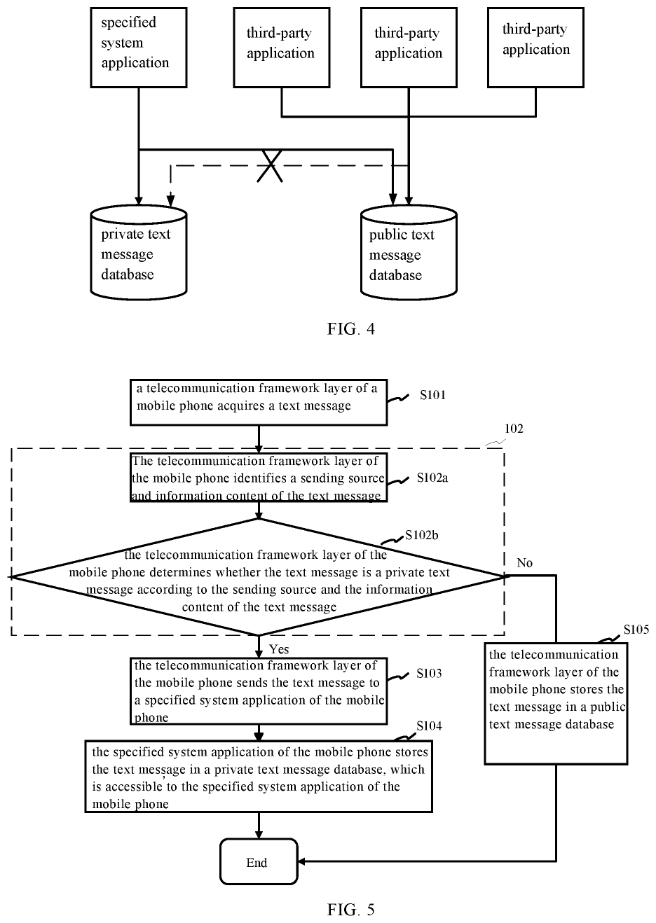

With reference to FIG. 4 which is a schematic diagram of a private text message database and a public text message database, the private text message database is accessible to the specified system application and is inaccessible to any other third-party application, which prevents the private text message of the user from being accessed and stolen by the third-party application, and prevent the third-party application from leaking to other platforms and being stolen; and the public text message database is accessible not only to the specified system application but also to the third-party applications except the specified system application, which makes it easy for the operator platform to access common text messages except the private text message to implement the corresponding marketing strategy.

According to the embodiment of the present disclosure, the framework layer analyzes whether the text message is a private text message and sends the private text message to the specified system application, and then the specified system application stores the private text message in the private text message database, so that the problems of access to the private text message of the user by the third-party application and information leakage can be effectively solved, thereby achieving the purpose of protecting various important private text messages of the user.

A text message processing method is further provided by still another embodiment of the present disclosure, and the text message processing method includes operations S101 to S105. It should be noted that the operations S101 and S103 to S105 in this embodiment are the same as those in the above embodiments, and thus are not repeated here.

In order to accurately and quickly determine whether a new text message is a private text message, as shown in FIG. 5, the operation S102 is further divided in this embodiment. Specifically, the operation of determining, by the telecommunication framework layer of the mobile phone, whether a text message is a private text message according to a preset rule (i.e., the operation S102) includes the following operations S102a and S102b.

At the operation S102a, a telecommunication framework layer of a mobile phone identifies a sending source and information content of a text message.

In the embodiment, the sending source of the text message includes a sender number, a text message code or the like. The telecommunication framework layer of the mobile phone identifies the sending source and the information content of the text message, so as to subsequently determine whether the text message is information about a bank transaction record, information about a verification code, express pickup information or other private test messages preset by the user.

Specifically, the text message sent by the sender of the text message to the mobile phone is a string of binary data at first, that is, a protocol data unit of text message, which is called PDU information, and the PDU information includes a plurality of fields, which mainly include a sender number (e.g., TP-OA), a timestamp (e.g., TP-SCTS), a text message code (e.g., TP-DCS) and text message content (e.g., TP-UD). The telecommunication framework layer of the mobile phone may identify the sending source and the information content of the text message according to the above information.

At the operation S102b, the telecommunication framework layer of the mobile phone determines whether the text message is a private text message according to the sending source and the information content of the text message.

For example, the sender number (e.g., TP-OA) of the text message is a fixed short number, such as a number of a banking system and a number of an operator system, and the mobile phone may quickly recognize the corresponding banking system by identifying the fixed short number, and then may recognize that the text message contains bank transaction information based on the text message content, such as the amount of transaction in the text message. Similarly, the telecommunication framework layer of the mobile phone may also recognize a text message containing information about a pickup code. The expression “verification code” generally appears in text messages including verification codes, a UCS2 code of the expression “verification code” is 9A8C8BC17801, the expression “verification code” is usually followed by specific information of a verification code, such as a string of numbers, and a UCS2 code range of the numbers is from 0x0030 to 0x0039. Moreover, the text messages containing verification codes are usually sent out by an SMS platform with a fixed short number, so that the telecommunication framework layer of the mobile phone may identify the text messages containing verification codes quickly.

For other information preset by the user, in a case where the other preset information is the private text message, a sending source of the private text message may not be identified as quickly as the sending source of the above text message because the private text message is rarely sent with a fixed short number. In order to quickly identify the sending source of the private text message, in some implementations, the user may set a corresponding text message sender of a private text message in the mobile phone, so that the framework layer of the mobile phone can quickly and accurately determine whether a text message sent by the corresponding text message sender is a private text message according to the contents of the text message when receiving the text message from the corresponding text message sender.

It should be noted that the above description is of the examples of identifying the private text message by the framework layer of the mobile phone, and the ways of identifying the private text message in the embodiment are not limited to the above description.

Compared with the foregoing embodiments, the present embodiment provides a method in which the telecommunication framework layer of the mobile phone identifies the sending source and the information content of the text message after receiving the new text message, and quickly and accurately determines whether the new text message is a private text message according to the identified sending source and information content of the text message, thereby laying the foundation for the security of the text message of the user and effectively protecting the private text messages.

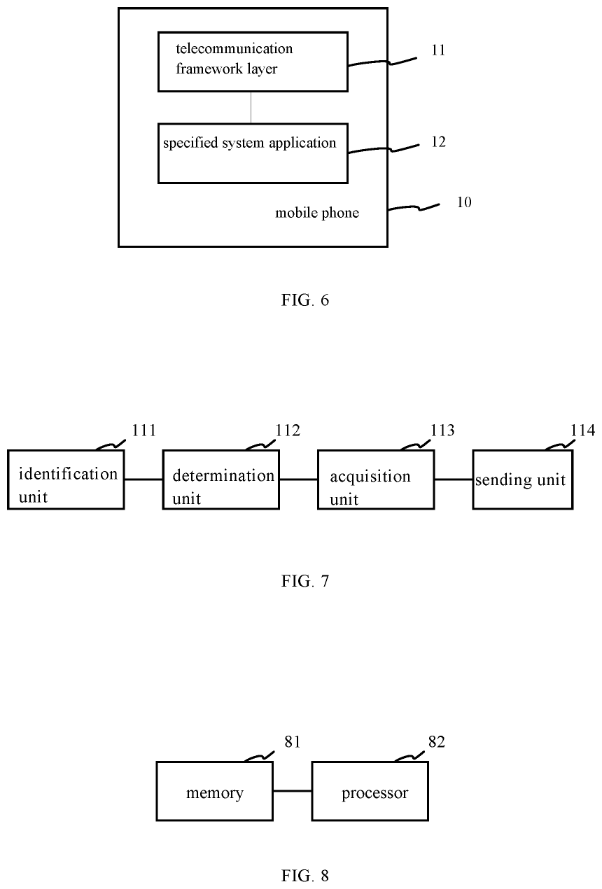

Based on the same technical idea, with reference to FIG. 6 which is a schematic structural diagram of a text message processing system according to an embodiment of the present disclosure, a text message processing system is provided and applicable to a mobile phone 10. The text message processing system includes a telecommunication framework layer unit 11 and a specified system application 12.

The telecommunication framework layer unit 11 is configured to acquire a text message, determine whether the text message is a private text message according to a preset rule, and send the text message to a specified system application in response to that the text message is the private text message.

The specified system application unit 12 is configured to store the text message in a private text message database, which is accessible to the specified system application of a terminal device.

In some implementations, the private text message includes at least one of the following information: information about a bank transaction record, information about a verification code, express pickup information or other information preset by a user.

In some implementations, in order to quickly and accurately identify whether a new text message received by the system is a private text message, as shown in FIG. 7, the telecommunication framework layer unit 11 includes an identification unit 111, a determination unit 112, an acquisition unit 113 and a sending unit 114.

The identification unit 111 is configured to identify a sending source and information content of the text message.

The determination unit 112 is configured to determine whether the text message is a private text message according to the sending source and the information content of the text message.

The acquisition unit 113 is configured to acquire a system application specified by a user.

The sending unit 114 is configured to send the text message to the system application specified by the user.

In some implementations, the telecommunication framework layer unit 11 is further configured to store the text message in a public text message database in response to that the text message is a non-private text message, and the public text message database is accessible not only to the specified system application but also to third-party applications except the specified system application.

Based on the same technical idea, as shown in FIG. 8, an embodiment of the present disclosure provides a terminal device, including a storage device (e.g., memory) 81 having a computer program stored therein, and a processor 82, the processor 82 runs the computer program stored in the storage device 81, to perform any of the text message processing methods described in the above embodiments.

Based on the same technical idea, an embodiment of the present disclosure correspondingly provides a storage medium having a computer program stored therein, when the computer program is executed by a processor, the processor performs any of the text message processing methods described in the above embodiments.

In summary, according to the technical solutions of the text message processing method and the text message processing system, the terminal device and the storage medium provided by the present disclosure, the telecommunication framework layer determines whether the text message is a private text message according to the preset rule after acquiring the text message, and sends the private text message to the specified system application in response to that the text message is the private text message, and the specified system application stores the private text message in the private text message database, which is accessible to the specified system application. Thus, the present disclosure overcomes the problem of leakage of important text message of the user from at least two aspects: message receiving and message storage, and can effectively protect various kinds of important information. Moreover, in the present disclosure, the telecommunication framework layer identifies the sending source and the content of the text message after receiving the text message, and quickly and accurately determines whether the text message is a private text message according to the sending source and the content of the text message, so as to lay the foundation for the security of the text message of the user and effectively protect the private text message. Further, in the present disclosure, in response to that the text message is a non-private text message, the telecommunication framework layer stores the non-private text message in the public text message database, which is accessible to not only the specified system application of the mobile phone but also to the third-party applications except the specified system application of the mobile phone, which makes it easy for the operator platform to implement the corresponding marketing strategy among the users under the condition that the security of the private text messages of the users is ensured.

It should be understood by those of ordinary skill in the art that all or some of the operations, the functional modules/units in the systems and the devices in the methods disclosed above may be implemented as software, firmware, hardware, or suitable combinations thereof. If implemented as hardware, the division between the functional modules/units stated above is not necessarily corresponding to the division of physical components; for example, one physical component may have a plurality of functions, or one function or operation may be performed through cooperation of several physical components. Some or all of the physical components may be implemented as software executed by a processor (such as a central processing unit, a digital signal processor or a microprocessor), or may be implemented as hardware, or may be implemented as an integrated circuit, such as an application specific integrated circuit. Such software may be distributed on a computer-readable medium, which may include a computer storage medium (or a non-transitory medium) and a communication medium (or a transitory medium). As well known by those of ordinary skill in the art, the term “computer storage medium” includes volatile/nonvolatile and removable/non-removable media used in any method or technology for storing information (such as computer-readable instructions, data structures, program modules and other data). The computer storage medium includes, but is not limited to, a Random Access Memory (RAM), a Read-Only Memory (ROM), an Electrically Erasable Programmable Read-Only Memory (EEPROM), a flash memory, a Compact Disc Read Only Memory (CD-ROM), a Digital Versatile Disc (DVD), a magnetic cassette, a magnetic tape, a magnetic disk, or any other medium which can be configured to store desired information and can be accessed by a computer. In addition, it is well known by those of ordinary skill in the art that the communication medium generally includes computer-readable instructions, data structures, program modules, or other data in modulated data signals such as carrier wave or other transmission mechanism, and may include any information delivery medium.

Finally, it should be noted that the above embodiments are intended to illustrate the technical solutions of the present disclosure, rather than limiting the present disclosure. Although the present disclosure is described in detail in conjunction with the above embodiments, it should be understood by those of ordinary skill in the art that changes may be made to the technical solutions described in the above embodiments, or equivalent substitutions of part or all of the technical features in the technical solutions may be made, but the essence of the corresponding technical solutions does not deviate from the scope of the technical solutions disclosed by the embodiments of the present disclosure due to those changes or substitutions.

1. A text message processing method, comprising:
acquiring a text message by a telecommunication framework layer;
determining, by the telecommunication framework layer, whether the text message is a private text message according to a preset rule;
in response to that the text message is the private text message, sending the text message to a specified system application by the telecommunication framework layer; and
storing, by the specified system application, the text message in a private text message database, which is accessible to the specified system application.

2. The method of claim 1, wherein the determining, by the telecommunication framework layer, whether the text message is the private text message according to the preset rule comprises:
identifying, by the telecommunication framework layer, a sending source and information content of the text message; and
determining, by the telecommunication framework layer, whether the text message is the private text message according to the sending source and the information content of the text message.

3. The method of claim 1, wherein the private text message comprises at least one of the following information:
information about a bank transaction record, information about a verification code, express pickup information or other information preset by a user.

4. The method of claim 1, further comprising:
in response to that the text message is a non-private text message, storing, by the telecommunication framework layer, the text message in a public text message database, which is accessible not only to the specified system application but also to third-party applications except the specified system application.

5. A text message processing system, comprising:
a telecommunication framework layer configured to acquire a text message, determine whether the text message is a private text message according to a preset rule, and send the text message to a specified system application in response to that the text message is a private text message; and
the specified system application configured to store the text message in a private text message database, which is accessible to the specified system application.

6. The system of claim 5, wherein the telecommunication framework layer comprises:
an identification unit configured to identify a sending source and information content of the text message; and
a determination unit configured to determine whether the text message is the private text message according to the sending source and the information content of the text message.

7. The system of claim 5, wherein the private text message comprises at least one of the following information:
information about a bank transaction record, information about a verification code, express pickup information or other information preset by a user.

8. The system of claim 5, wherein the telecommunication framework layer is further configured to: store the text message in a public text message database in response to that the text message is a non-private text message, and the public text message database is accessible not only to the specified system application but also to third-party applications except the specified system application.

9. A terminal device, comprising a storage device having a computer program stored therein, and a processor, the processor runs the computer program stored in the storage to perform the text message processing method of claim 1.

10. A computer-readable storage medium having a computer program stored therein, the computer program is executed by a processor, so that the processor performs the text message processing method of claim 1.
